(19) United States
(12) Patent Application Publication
(10) Pub. No.: US 2005/0187347 A1
(43) Pub. Date: Aug. 25, 2005

(54) Golf ball composition having substantially no ZDA coagent

(76) Inventors: Michael J. Sullivan, Barrington, RI (US); Michael D. Jordan, Newport, RI (US); Derek A. Ladd, Acushnet, MA (US); William E. Morgan, Barrington, RI (US); David A. Bulpett, Boston, MA (US)

Correspondence Address: ACUSHNET COMPANY, 333 BRIDGE STREET, P. O. BOX 965, FAIRHAVEN, MA, 02719, US

(21) Appl. No.: 11/109,341

(22) Filed: Apr. 19, 2005

Related U.S. Application Data
(63) Continuation-in-part of application No. 10/279,506, filed on Oct. 24, 2002.
(63) Continuation-in-part of application No. 10/208,580, filed on Jul. 30, 2002.
Application No. 10/208,580 is a continuation-in-part of application No. 09/815,753, filed on Mar. 23, 2001, now Pat. No. 6,494,795.
Application No. 10/208,580 is a continuation-in-part of application No. 10/164,809, filed on Jun. 7, 2002, now Pat. No. 6,774,187.

(51) Int. Cl. C08L 9/00; C08L 83/00; A63B 37/04; A63B 37/06

(52) U.S. Cl. 525/100; 525/479; 473/373

(57) ABSTRACT

A golf ball comprising at least a core, a cover layer and optionally at least one intermediate layer disposed between the core and the cover layer. At least a layer of the golf ball is formed from a polymer composition comprising peroxide-cured diene rubber formulations that are substantially free of ZDA.

### CROSS-REFERENCE TO RELATED APPLICATIONS

The present application is a continuation in part of co-pending U.S. patent application Ser. No. 10/279,506, filed Oct. 24, 2002, and a continuation-in-part of co-pending U.S. patent application Ser. No. 10/208,580, which is a continuation-in-part of co-pending U.S. patent application Ser. Nos. 09/815,753, now U.S. Pat. No. 6,494,795 and. 10/164,809, now U.S. Pat. No. 6,774,187, each of which is incorporated herein by reference in its entirety.

### FIELD OF THE INVENTION

This invention relates generally to golf balls and, more specifically, to a high performance golf ball having at least one layer comprising a peroxide-cured diene rubber formulation containing substantially no reactive co-agent zinc diacrylate (ZDA).

### BACKGROUND OF THE INVENTION

Golf balls have been designed to provide particular playing characteristics. These characteristics generally include initial ball velocity, coefficient of restitution (CoR), compression, weight distribution and spin of the golf ball, which can be optimized for various types of players.

Golf balls can generally be divided into solid and wound balls. Solid golf balls include single-layer, dual-layer (i.e., solid core and a cover), and multi-layer (i.e., solid core of one or more layers, one or more intermediate layers and/or a cover of one or more layers) golf balls. Wound golf balls typically include a solid, hollow, or fluid-filled center, surrounded by tensioned elastomeric thread, and a cover.

Generally, the hardness of a golf ball or a golf ball core is one of the factors used in designing golf balls. Typically, when a hard ball, e.g., possessing high compression values and low deformation, is struck by a club it typically has high CoR and high initial velocity after impact with a golf club. However, a hard ball has a hard feel and a softer ball, e.g., lower compression value and high deformation, has a soft feel. Recently developed solid balls have a core, at least one intermediate layer, and a cover. The intermediate layer improves playing characteristics of solid balls, and can be formed from thermoset or thermoplastic materials.

Golf ball cores can be formed using zinc diacrylate (ZDA) and/or zinc dimethacrylate (ZDMA) co-agents to take part in the cross-linking of polybutadiene. A small amount of ZDA and/or ZDMA produces a golf ball core with lower initial velocity and lower compression than a larger amount of coagent. The use of ZDA coagent to increase velocity also increases hardness and contributes to a hard feel.

U.S. patent application publication no. 2004/0162160 A1 describes a golf ball with a sulfur-cured inner core component, optionally free of ZDA. However, it does not teach or suggest organosulfur cis-to-trans conversion agents, or peroxide-cured diene rubber having no ZDA. Each of U.S. Pat. Nos. 6,277,034 and 6,638,184 teaches at least two parts of ZDA (2-50 and preferably 5-25 pphr). Additionally, these patents do not teach or suggest a composition having organosulfur compounds. U.S. Pat. No. 6,126,559 describes golf balls having thick (ionomer) cover layer. According to this patent, the core contains 5-14 and, preferably, 15-30 pphr ZDA and, alternatively, a sulfur-cured core not containing ZDA. However, this issued patent does not teach or suggest a polymer composition comprising peroxide-cured diene rubber formulation that is substantially free of ZDA or a composition having organosulfur compounds.

Hence, there remains a need in the art for low compression golf balls that have high coefficient of restitution.

### SUMMARY OF THE INVENTION

The present invention is directed to a golf ball comprising a core, a cover layer, and optionally at least one intermediate layer disposed between the core and the cover. At least one of the core, the intermediate layer and the cover layer include a polymer composition containing a peroxide-cured diene rubber formulation that is substantially free of ZDA. This layer should have a relatively low compression. Optionally, this layer includes cis-to-trans conversion agent/catalyst.

In one embodiment, the inner core may include a peroxide-cured or, alternatively, a sulfur-cured diene rubber formulation that is substantially free of reactive co-agent, such as ZDA.

In another embodiment, the cover layer of the golf ball may be formed of a composition that substantially free of reactive co-agent, such as ZDA. Optionally, in addition or, in the alternative, the core and/or the intermediate layer do not substantially include reactive co-agent, such as ZDA, in their composition.

Alternatively, the polymer composition of the present invention may include a peroxide and pentachlorothiophenol (PCTP).

In another embodiment, the core or the cover layer, instead of having a coagent such as ZDA or ZDMA, include type II co-crosslinking agents, such as ones described in U.S. patent application publication no. 2004/0214661, which is incorporated herein by reference in its entirety. The composition of the present invention provides a golf ball that has high coefficient of restitution at all impact speeds, while maintaining a soft feel and control characteristics.

It is to be understood that both the foregoing general description and the following detailed description are exemplary and explanatory only, and are intended to provide a further explanation of the present invention, as claimed.

### BRIEF DESCRIPTION OF THE DRAWINGS

In the accompanying drawings, which form a part of the specification and are to be read in conjunction therewith, and in which like reference numerals are used to indicate like parts in the various views:

FIG. 1 is a cross-sectional view of a first embodiment of the present invention; and

FIG. 2 is a cross-sectional view of a second embodiment of the present invention.

### DETAILED DESCRIPTION OF THE INVENTION

In accordance to the present invention, a golf ball is provided that includes a core, a cover layer, and optionally at least one intermediate layer disposed between the core and the cover layer. At least one of the core layers, one or more of the intermediate layers, or one of the cover layers includes a polymer composition containing at least one peroxide-cured diene rubber formulation that is substantially free of reactive co-agent, such as ZDA.

Suitable base diene elastomers include thermosetting or thermoplastic materials such as, thermosetting polydiene rubber, such as polybutadiene, polyisoprene, ethylene propylene diene monomer rubber, ethylene propylene rubber, natural rubber, balata, butyl rubber, halobutyl rubber, hydrogenated nitrile butadiene rubber (HNBR), nitrile rubber (NBR), silicone rubber, styrene butadiene rubber or any styrenic block copolymer, such as styrene ethylene butadiene styrene rubber, etc., metallocene, or other single-site catalyzed polyolefin, polyurethane copolymers, e.g. with silicone. Other diene rubbers that can be used in the present invention are listed in U.S. patent application Ser. No. 10/882,130, which is incorporated herein by reference in its entirety.

Additional polymers may also be incorporated into the base polymer. Examples of suitable additional polymers include, but are not limited to, thermoplastic elastomer, thermoset elastomer, synthetic rubber, thermoplastic vulcanizate, copolymeric ionomer, terpolymeric ionomer, polycarbonate, polyamide, copolymeric polyamide, polyesters, polyvinyl alcohols, acrylonitrile-butadiene-styrene copolymers, polyarylate, polyacrylate, polyphenylene ether, impact-modified polyphenylene ether, high impact polystyrene, diallyl phthalate polymer, metallocene catalyzed polymers, styrene-acrylonitrile (SAN) (including olefin-modified SAN and acrylonitrile-styrene-acrylonitrile), styrene-maleic anhydride (S/MA) polymer, styrenic copolymer, functionalized styrenic copolymer, functionalized styrenic terpolymer, styrenic terpolymer, cellulose polymer, liquid crystal polymer (LCP), ethylene-propylene-diene terpolymer (EPDM), ethylene-vinyl acetate copolymers (EVA), ethylene-propylene copolymer, ethylene vinyl acetate, polyurea, and polysiloxane or any metallocene-catalyzed polymers of these species.

Suitable polyamides for use as an additional polymeric material in compositions within the scope of the present invention also include resins obtained by: (1) polycondensation of (a) a dicarboxylic acid, such as oxalic acid, adipic acid, sebacic acid, terephthalic acid, isophthalic acid, or 1,4-cyclohexanedicarboxylic acid, with (b) a diaamine, such as ethylenediamine, tetramethylenediamine, pentamethylenediamine, hexamethylenediamine, or decaamethylenediamine, 1,4-cyclohexyldiamine, or m-xylylenediamine; (2) a ring-opening polymerization of cyclic lactam, such as C-caprolactam or Ω-laurolactam; (3) polycondensation of an aminocarboxylic acid, such as 6-aminocaproic acid, 9-aminononanoic acid, 11-aminoundecanoic acid, or 12-aminododecanoic acid; or (4) copolymerization of a cyclic lactam with a dicarboxylic acid and a diaamine. Specific examples of suitable polyamides include Nylon 6, Nylon 66, Nylon 610, Nylon 11, Nylon 12, copolymerized Nylon, Nylon MXD6, and Nylon 46.

Other preferred materials suitable for use as an additional material in compositions within the scope of the present invention include polyester elastomers marketed under the trade name SKYPEL® by SK Chemicals of South Korea, or diblock or triblock copolymers marketed under the trade name SEPTON® by Kuraray Corporation of Kurashiki, Japan, and KRATON® by Kraton Polymers Group of Companies of Chester, United Kingdom. All of the materials listed above can provide for particular enhancements to the core and/or ball layers prepared within the scope of the present invention.

The peroxide-cured diene rubber of the present invention is a product of blending a diene rubber with an initiating agent, followed by curing in a mold for a set time at an elevated temperature and pressure. Suitable initiating agents include dicumyl peroxide; 2,5-dimethyl-2,5-di(t-butylperoxy) hexane; 2,5-dimethyl-2,5-di(t-butylper-oxy)hexyne; 2,5-dimethyl-2,5-di(benzoylperoxy)hexane; 2,2′-bis(t-butylperoxy)-di-iso-propylbenzene; 1,1-bis(t-butylperoxy)-3,3,-5-trimethyl cyclohexane; n-butyl 4,4-bis(t-butylperoxy)valerate; t-butyl perbenzoate; benzoyl peroxide; n-butyl 4,4′-bis(butylperoxy) valerate; di-t-butyl peroxide; or 2,5-di-(t-butylperoxy)-2,5 dimethyl hexane, lauryl peroxide, t-butyl hydroperoxide, a-a bis(t-butylperoxy) diisopropylbenzene, di(2-t-butylperoxyisopropyl)benzene peroxide, 3,3,5-trimethyl cyclohexane, di-t-amyl peroxide, di-t-butyl peroxide. Preferably, the polymer composition includes from about 0.05 to about 3.0 phr initiating agent to produce the peroxide-cured diene rubber of the present invention.

Optionally, antioxidants may also be included. Antioxidants are compounds that prevent the breakdown of the elastomers. Some exemplary antioxidants that may be used in the present invention include, but are not limited to, quinoline type antioxidants, amine type antioxidants, and phenolic type antioxidants.

Other ingredients such as accelerators, e.g., tetra methylthiuram, processing aids, processing oils, dyes and pigments, as well as other additives known to one skilled in the art may also be used in the present invention in amounts sufficient to achieve the purpose for which they are typically used.

The polymeric composition of the present invention may also include a cis-to-trans catalyst. Preferably, the composition of the present invention contains from about 0.05 to about 3.0 phr cis-to-trans catalyst. Suitable cis-to-trans catalysts include an organosulfur or metal-containing organosulfur compound, a substituted or unsubstituted aromatic organic compound that does not contain sulfur or metal, an inorganic sulfide compound, an aromatic organometallic compound, or mixtures thereof. The cis-to-trans catalyst component may include one or more of the cis-to-trans catalysts described herein. For example, the cis-to-trans catalyst may be a blend of an organosulfur component and an inorganic sulfide component.

As used herein, “cis-to-trans catalyst” means any component or a combination thereof that will convert at least a portion of cis-isomer to trans-isomer at a given temperature. The cis-to-trans catalyst component may include one or more cis-to-trans catalysts described herein, but typically includes at least one organosulfur component, a Group VIA component, an inorganic sulfide, or a combination thereof. In one embodiment, the cis-to-trans catalyst is a blend of an organosulfur component and an inorganic sulfide component or a Group VIA component.

As used herein when referring to the invention, the term “organosulfur compound(s)” or “organosulfur component(s),” refers to any compound containing carbon, hydrogen, and sulfur. As used herein, the term “sulfur component” means a component that is elemental sulfur, polymeric sulfur, or a combination thereof. It should be further understood that “elemental sulfur” refers to the ring structure of S.sub.8 and that “polymeric sulfur” is a structure including at least one additional sulfur relative to the elemental sulfur. Catalyst component may include one or more cis-to-trans catalysts described herein, but typically includes at least one organosulfur component, a Group VIA component, an inorganic sulfide, or a combination thereof. In one embodiment, the cis-to-trans catalyst is a blend of an organosulfur component and an inorganic sulfide component or a Group VIA component.

The preferred organosulfur components include 4,4′-diphenyl disulfide, 4,4′-ditolyl disulfide, or 2,2′-benzamido diphenyl disulfide, or a mixture thereof. Additional preferred organosulfur components include, but are not limited to, pentachlorothiophenol, zinc pentachlorothiophenol (PCTP) or metal salts thereof, non-metal salts of PCTP, such as ammonium salt of pentachlorothiophenol magnesium pentachlorothiophenol, cobalt pentachlorothiophenol, pentafluorothiophenol, zinc pentafluorothiophenol, and blends thereof. Preferred candidates are pentachlorothiophenol (available from Strucktol Company of Stow, Ohio), zinc pentachlorothiophenol (available from eChinachem of San Francisco, Calif.), and blends thereof. Additional examples are described in commonly-owned co-pending U.S. patent application Ser. No. 10/882,130, which was previously incorporated by reference in its entirety.

The organosulfur cis-to-trans catalyst, when present, is preferably present in an amount sufficient to produce the reaction product so as to contain at least about 12 percent trans-polybutadiene isomer, but typically is greater than about 32 percent trans-polybutadiene isomer based on the total resilient polymer component. Alternatively, cis-to-trans catalyst is present in the polymeric composition by at least about 0.01 phr, preferably at least about 0.05 phr, more preferably at least about 0.1 phr, even more preferably greater than about 0.25 phr, optionally greater than about 2 phr, such as greater than about 2.2 phr, or even greater than about 2.5 phr, but no more than about 10 phr, preferably less than about 5 phr, more preferably less than about 2 phr, even more preferably less than about 1.1 phr, such as less than about 0.75 phr, or even less than about 0.6 phr.

Metal-containing organosulfur components may also be used according to the invention. Suitable metal-containing organosulfur components include, but are not limited to, cadmium, copper, lead, and tellurium analogs of diethyldithiocarbamate, diamyldithiocarbamate, and dimethyldithiocarbamate, or mixtures thereof. Additional suitable examples can be found in commonly owned and co-pending U.S. patent application Ser. No. 10/402,592. Other cis-to-trans catalysts include those disclosed in U.S. Pat. Nos. 6,525,141; 6,465,578; 6,184,301; 6,139,447; 5,697,856; 5,816,944; and 5,252,652, which are incorporated herein by reference in their entireties.

Suitable substituted or unsubstituted aromatic organic components that do not include sulfur or a metal include, but are not limited to, 4,4′-diphenyl acetylene, azobenzene, or a mixture thereof. The aromatic organic group preferably ranges in size from C₆ to C₂₀, and more preferably from C₆ to C₁₀. Suitable inorganic sulfide components include, but are not limited to titanium sulfide, manganese sulfide, and sulfide analogs of iron, calcium, cobalt, molybdenum, tungsten, copper, selenium, yttrium, zinc, tin, and bismuth

The cis-to-trans catalyst can also include a Group VIA component. Elemental sulfur and polymeric sulfur are commercially available from, e.g., Elastochem, Inc. of Chardon, Ohio. Exemplary sulfur catalyst compounds include PB(RM-S)-80 elemental sulfur and PB(CRST)-65 polymeric sulfur, each of which is available from Elastochem, Inc. An exemplary tellurium catalyst under the trade name TELLOY®, and an exemplary selenium catalyst under the trade name VANDEX® are each commercially available from RT Vanderbilt. A further list of suitable organosulfur compounds, halogenated thiophenols, and disulfides are disclosed in U.S. patent application Ser. No. 10/882,130, which was previously incorporated by reference in its entirety.

Optionally, the polymeric composition of the present invention includes a sulfur-cured diene rubber. The sulfur-cured diene rubber is a product of treating a diene rubber with a vulcanizing agent including sulfur; insoluble sulfur; 4-morpholinyl-2-benzothiazole disulfide; dipentamethylenethiuram hexasulfide; thiuram disulfides; N-oxydiethylene 2-benzothiazole sulfonamide; N,N-diorthotolyguanidine; bismuth dimethyldithiocarbamate; N-cyclohexyl 2-benzothiazole sulfonamide; or N,N-diphenylguanidine. Preferably, the polymeric composition includes from about 1.0 to about 5.0 phr vulcanizing agent to produce the sulfur-cured diene rubber. Preferably, in a sulfur-cured system, an accelerator is usein in an amount of from about 0.5 to about 3.0 phr. Some examples of accelerators that can be used in the present invention include, but are not limited to, a guanidine, a mercaptobenzothiazole, a sulfenamide, thiuram or dithiocarbamate.

Silicone materials also are well suited for blending into the composition of the present invention. These include oligomers, prepolymers, or polymers, with or without additional reinforcing filler. One type of silicone material that is suitable can incorporate at least 1 alkenyl group having at least 2 carbon atoms in their molecules. Examples of these alkenyl groups include, but are not limited to, vinyl, allyl, butenyl, pentenyl, hexenyl and decenyl. The alkenyl functionality can be located at any location of the silicone structure, including one or both terminals of the structure. The remaining (i.e., non-alkenyl) silicon-bonded organic groups in this component are independently selected from hydrocarbon or halogenated hydrocarbon groups that contain no aliphatic unsaturation. Non-limiting examples of these include: alkyl groups, such as methyl, ethyl, propyl, butyl, pentyl and hexyl; cycloalkyl groups, such as cyclohexyl and cycloheptyl; aryl groups, such as phenyl, tolyl and xylyl; aralkyl groups, such as benzyl and phenethyl, and halogenated alkyl groups, such as 3,3,3-trifluoropropyl and chloromethyl. Another type of silicone material suitable for use in the present invention is one having hydrocarbon groups that lack aliphatic unsaturation. Specific examples of suitable silicones for use in making compositions of the present invention include trimethylsiloxy-endblocked dimethylsiloxane-methylhexenylsiloxane copolymers; dimethylhexenlylsiloxy-endblocked dimethylsiloxane-methylhexenylsiloxane copolymers; trimethylsiloxy-endblocked dimethylsiloxane-methylvinylsiloxane copolymers; trimethylsiloxy-endblocked methylphenylsiloxane-dimethylsiloxane-methylvinylsiloxane copolymers; dimethylvinylsiloxy-endblocked dimethylpolysiloxanes; dimethylvinylsiloxy-endblocked dimethylsiloxane-methylvinylsiloxane copolymers; dimethylvinylsiloxy-endblocked methylphenylpolysiloxanes; dimethylvinylsiloxy-endblocked methylphenylsiloxane-dimethylsiloxane-methylvinylsiloxane copolymers; and the copolymers listed above, in which at least one end group is dimethylhydroxysiloxy. Commercially available silicones suitable for use in compositions within the scope of the present invention include Silastic® by Dow Coming Corp. of Midland, Mich., Blensil® by GE Silicones of Waterford, N.Y., and Elastosil® by Wacker Silicones of Adrian, Mich. Preferably, the silicone material of the present invention is a polydimethyl siloxane.

The novel polymeric composition that is substantially free of ZDA in accordance to the present invention is usable in a core layer, one or more of the intermediate layers, and/or a cover layer of the golf ball. Preferably, the composition is utilized at least in the core of the golf ball.

Suitable co-crosslinking agents, preferably, include di- or polyunsaturation and at least one readily extractable hydrogen in the alpha position to the unsaturated bonds. Useful co-crosslinking agents include, but are not limited to, mono- or polyfunctional unsaturated carboxylate metallic compounds, polyesters of unsaturated carboxylic acids, polyamides of unsaturated carboxylic acids, esteramides of unsaturated carboxylic acids, bismaleimides, allyl esters of cyanurates, allyl esters of isocyanurates, allyl esters of aromatic acids, mono- and polyunsaturated polycarboxylic acids, anhydrides of mono- and polyunsaturated polycarboxylic acids, monoesters and polyesters of mono- and polyunsaturated polycarboxylic acids, monoamides and polyamides of mono- and polyunsaturated polycarboxylic acids, esteramides and polyesteramides of mono- and polyunsaturated polycarboxylic acids, liquid vinyl polydienes, and mixtures thereof. Unsaturated carboxylate metallic compounds are Type I co-crosslinking agents. Type I co-crosslinking agents have different effect on the curing characteristics of the system than Type II co-crosslinking agent. Type I co-crosslinking agents, generally, form relatively more reactive free radicals which increase both cure rate and the state of cure of the system. Furthermore, Type I co-crosslinking agents, primarily form ionic crosslinks. In contrast, Type II co-crosslinking agents relatively form less reactive and more stable free radicals and primarily increase the state of cure of the elastomer. Furthermore, Type II co-crosslinking agents primarily form carbon-carbon crosslinks. The co-crosslinking agent may be present in an amount of at least about 0.1 parts per one-hundred parts by weight of the base rubber (phr), such as from about 0.5 phr to about 80 phr. The amount of carbon-carbon-crosslinks in the resulting thermoset material may be no less than the amount of ionic crosslinks.

Unsaturated carboxylic acids may be condensed with polyamines (forming polyamides), polyols (forming polyesters), or aminoalcohols (forming esteramides). Non-limiting examples of unsaturated carboxylic acid condensates include tripropylene glycol diacrylate, Bisphenol A diglycidylether diacrylate, 1,6-Hexanediol diacrylate, 1,4-butanediol dimethacrylate, ethyleneglycol dimethacrylate, polyethylene glycol dimethacrylate, diethylene glycol dimethacrylate, urethane dimethacrylate, tetraethylene glycol dimethacrylate, triethylene glycol dimethacrylate, trimethylolpropane trimethacrylate, pentaerythritol triacrylate, and trimethylolpropane triacrylate.

Non-limiting example of bismaleimide include N,N′-m-phenylenedimaleimide (HVA-2, available from Dupont). Non-limiting examples of allyl esters include triallyl cyanurate (Akrosorb.RTM. 19203, available from Akrochem Corp. of Akron, Ohio), triallyl isocyanurate (Akrosorb.RTM. 19251, also available from Akrochem Corp.), and triallyl trimaletate (TATM, available from Sartomer Company of Exton, Pa.). Non-limiting examples of mono- or polyunsaturated polycarboxylic acids and derivatives thereof include citraconic acid, itaconic acid, fumaric acid, maleic acid, mesaconic acid, aconitic acid, maleic anhydride, itaconic anhydride, citraconic anhydride, poly(meth)acrylic acid, polyitaconic acid, copolymers of (meth)acrylic acid and maleic acid, copolymers of (meth)acrylic acid and styrene, and fatty acids having a C₆ or longer chain, such as hexadecenedioic acid, octadecenedioic acid, vinyl-tetradecenedioic acid, eicosedienedioic acid, dimethyl-eicosedienedioic acid, 8-vinyl-10-octadecenedioic acid, anhydrides thereof, methyl, ethyl, and other linear or branched alkyl esters thereof, amides thereof, esteramides thereof, and mixtures thereof.

In a first example, the core comprises the polymeric composition described above, which includes at least a peroxide-cured diene rubber formulation that is substantially free of ZDA and, optionally, other additives described above. The core, in this example has a diameter of about 1.4 inches or less, a compression of about 70 or less, and a coefficient of restitution of from about 0.7 to about 0.9.

The intermediate layer has a thickness of from about 0.1 inch to about 0.05 inch and includes a composition having at least two ionomers. The ionomers that may be used in this example are described in U.S. patent application Ser. No. 10/841,031, which is incorporated herein by reference in its entirety. The combination of the core and the intermediate layer results in a compression of about 50 or more, a coefficient of restitution of about 0.78 or more at 125 ft/s.

The cover layer of this first example includes partially- or fully-neutralized ionomers, metallocene-catalyzed polymers, single-site catalyzed polymers, polyesters, polyethers, balata, cross-linked diene rubbers, styrene block copolymers, polyurethanes, polyureas, polyurethane-ureas, polyurea-urethanes, or non-ionic fluoropolymers. Specific examples of some of these compounds are provided in U.S. patent application Ser. No. 10/841,031, which was previously incorporated by reference in its entirety. The total thickness of the cover layer is less than about 0.125 inch. When the cover layer includes an innermost layer, the innermost layer is about 0.02 inch to about 0.1 inch thick, more preferably, 0.01 inch to about 0.09 inch and, most preferably, 0.015 inch to about 0.07 inch. When the cover layer includes an intermediate cover layer, preferably, it is from about 0.01 inch to about 0.05 inch thick. The outer cover layer is about 0.02 inch to about 0.04 inch thick. The intermediate layer and the cover layer of this exemplary embodiment of the present invention are described in more detail in the co-pending U.S. patent application Ser. No. 10/841,031, which is incorporated herein by reference in its entirety.

In a second example, the core comprises the polymeric composition described above, which includes at least a peroxide-cured diene rubber formulation that is substantially free of ZDA and, optionally, other additives described above. In this example, the cover has a thickness of about 0.1 inch or greater, such as from about 0.1 inch to about 0.25 inch and is formed from a composition having a first ionomer being partially- or fully-neutralized by a first metal cation and a second ionomer being neutralized by a second metal cation different from the first. Alternatively, the cover layer is formed from partially- or fully-neutralized ionomers, metallocene-catalyzed polymers, single-site catalyzed polymers, polyesters, polyethers, and other polymers. The cover layer of this example is described, in more detail, in the co-pending U.S. patent application Ser. No. 10/845,721, which is incorporated herein by reference in its entirety.

In a third example, the golf ball includes a core, at least one inner cover layer encasing the core, and an outer cover layer encasing the inner cover layer. The outer cover layer has a thickness of from about 0.02 to about 0.05 inch, formed from the polymeric composition described above, which is generally a peroxide-cured diene rubber formulation that is substantially free of ZDA.

The inner cover layer has a thickness of 0.005 to about 0.05 inch. The inner cover layer includes at least one material chosen from polyamides, polyesters, fluoropolymers, silicones, ionomers, cross-linked rubbers, and mixtures thereof.

The core in this example includes a center and at least one outer core layer. Preferably, the core has a diameter of at least about 1.5 inches. Preferably, the outer core layer comprises a flexible, low compression, high CoR rubber composition and the inner core comprises a low deformation material. The inner core and the cover layer of this example are described, in more detail, in the co-pending U.S. patent application Ser. No. 10/845,937, which is incorporated herein by reference in its entirety.

In a fourth example, the golf ball has an inner core that is pre-formed and non-spherical, an outer core embedding the inner core, and a cover. The inner and outer core materials preferably have substantially different material properties so that there is a predetermined relationship between the inner and outer core materials, to achieve the desired playing characteristics of the ball. For instance, the inner core may be constructed from a rigid material having a high flexural modulus. The outer core, on the other hand, is preferably formed from the polymeric composition described above, which is generally a peroxide-cured diene rubber formulation that is substantially free of ZDA. In another example, the inner core comprises the polymeric composition described above, and the outer core includes polymers such as, but not limited to, natural rubbers, including cis-polyisoprene, trans-polyisoprene or balata, synthetic rubbers including 1,2-polybutadiene, cis-polybutadiene, trans-polybutadiene, polychloroprene, poly(norbornene), polyoctenamer and polypentenamer among other diene polymers. It is understood by one having ordinary skill in the art that in this embodiment the inner and outer core can be formed from the same polymer or polymeric composition.

The cover of this exemplary golf ball may include one or more layers. The outer cover layer is formed from a relatively soft thermoset material in order to replicate the soft feel and high spin play characteristics of a balata ball when the balls of the present invention are used for pitch and other “short game” shots. In particular, the outer cover layer should have a material Shore D hardness of less than 65 or from about 30 to about 60, preferably from about 35 to about 50 and, most preferably, from about 40 to about 45. Additionally, the material of the outer cover layer has a degree of abrasion resistance in order to be suitable for use as a golf ball cover. The outer cover layer may include any suitable thermoset material, which is formed from a castable reactive liquid material. The preferred materials for the outer cover layer include, but are not limited to, thermoset urethanes and polyurethanes, thermoset urethane ionomers and thermoset urethane epoxies. Examples of suitable polyurethane ionomers are disclosed in U.S. Pat. No. 5,692,974 entitled “Golf Ball Covers,” the disclosure of which is incorporated herein by reference in its entirety. The cover layer in this example is described, in more detail, in U.S. patent application Ser. No. 10/241,305, which is incorporated herein by reference in its entirety.

In a fifth example, the golf ball of the present invention includes a thin layer encasing a core, wherein the thin layer is encased by a cover. The core in this alternative golf ball, preferably, is formed from the polymeric composition described above, namely a polymer comprising of peroxide-cured diene rubber formulation that is substantially free of ZDA. Preferably, the diameter of the core is about 1.62 inches or less.

The thin layer encasing the core has a thickness of from about 0.0078 to about 0.05 inch and includes a diene polymer cross-linked with at least about 50 phr of a reactive co-agent. Preferably, the reactive co-agent includes a metal salt of diacrylate, dimethacrylate, or monomethacrylate. Examples of the metal salt include zinc, magnesium, calcium barium, tin, aluminum, lithium, sodium, potassium, iron, zirconium, and bismuth.

The cover layer that encases the thin layer has a thickness of from about 0.01 to about 0.2 inch, preferably from about 0.01 to about 0.05 inch, more preferably from about 0.02 to about 0.04 inch. The outer cover layer is formed from a relatively soft thermoset material in order to replicate the soft feel and high spin play characteristics of a balata ball when the balls are used for pitch and other “short game” shots. Other examples of the thin layer and the cover layer are described, in detail, in the parent U.S. patent application Ser. No. 10/208,580, which was previously incorporated by reference in its entirety.

In a sixth example, the golf ball of the present invention includes an innermost core, a cover, and an intermediate layer disposed between the innermost core and the cover. Preferably, the intermediate layer (or the outer core) comprises the polymeric composition described above, which contains at least a peroxide-cured rubber formulation that is substantially free of ZDA. Furthermore, the innermost core and the intermediate layer have a compression of greater than about 60. Preferably, the thickness of the intermediate layer is from about 0.001 inch to about 0.2 inch. In this example, the core preferably has a hardness of at least about 70 Shore C and, optionally, a compression that is greater than about 70. Additionally, the cover includes a thermoset polymer having a hardness of from about 45 to about 60 Shore D and a thickness of from about 0.02 inch to about 0.1 inch. The innermost core and the cover layer of this example are described, in more detail, in the parent U.S. patent application Ser. No. 10/279,506, which was previously incorporated by reference in its entirety.

In another example, one of the layers of the golf ball of the present invention may be a low deformation layer comprising of a durable, low deformation material such as metal, rigid plastics, or polymers re-enforced with high strength organic or inorganic fillers or fibers, or blends or composites thereof, as described in parent U.S. patent application Ser. No. 10/279,506, which was previously incorporated by reference in its entirety.

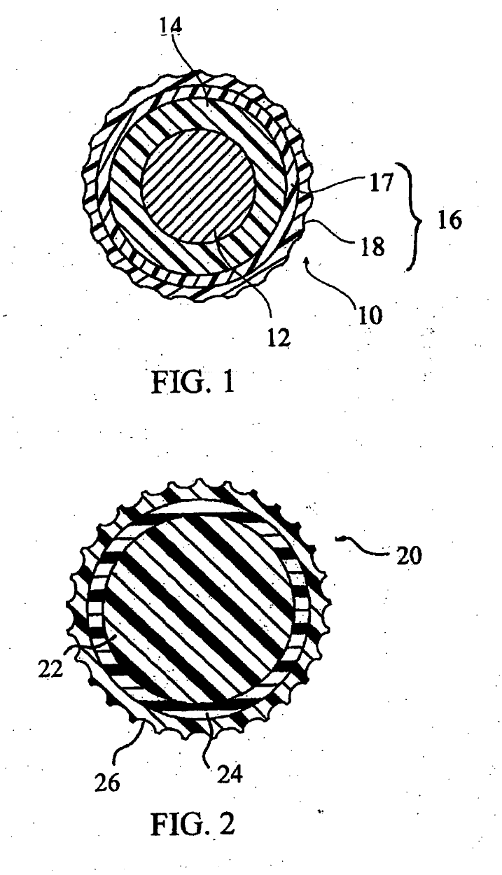

In accordance with FIG. 1 of the present invention, golf ball 10 comprises at least two core layers—an innermost core 12 and an outer core 14—and a cover 16. Outer core 14 comprises the polymeric composition having a peroxide-cured diene rubber formulation that is substantially free of ZDA, as described above. This composition provides a flexible, low compression, high CoR characteristics. Inner core 12 comprises the low deformation material as described in the parent U.S. patent application Ser. No. 10/279,506, which was previously incorporated by reference in its entirety. Inner core 12 resists deformation at high club speeds to maintain the CoR at an optimal level, while outer layer 14 provides high CoR at slower club speeds and the preferred softness for high iron club play. The inventive ball 10, therefore, enjoys high initial velocity and high CoR at high and low club head speeds, while maintaining a desirable soft feel and soft sound for greenside play. It is understood by one skilled in the art that inner layer 12 may also, or alternatively, include the polymeric composition that makes outer core 14.

Preferably, the inner core 12 has a flexural modulus in the range of about 25,000 psi to about 250,000 psi and a durometer hardness in the range of greater than about 70 Shore C. The compression of inner core 12 is preferably greater than about 60. More preferably, the compression is greater than about 70 and, most preferably, greater than about 80. Shore hardness is measured according to ASTM D-2240-00, and flexural modulus is measured in accordance to ASTM D6272-98 about two weeks after the test specimens are prepared.

Preferably, outer core 14 is softer and has a lower compression than inner core 12. Preferably, outer core 14 has a flexural modulus of about 500 psi to about 25,000 psi. More preferably, the flexural modulus is less than about 15,000 psi. Outer core 14, preferably, has a hardness of about 25 to about 70 Shore C. More preferably, the hardness is less than 60 Shore C.

One way to achieve the difference in hardness between inner core 12 and outer core 14 is to make inner core 12 from an un-foamed polymer, and to make outer core 14 from the polymeric composition described above. Alternatively, the inner and outer cores are formed from the same polymer or polymeric composition, which has a peroxide-cured diene rubber formulation that is substantially free of ZDA and, optionally, other additives described above; however, the ratio of the additives in outer core 14 may be different from the ratio of the additives in inner core 12, so that outer core 14 has a lower compression compared to inner core 12.

The dimensions of inner core 12 and outer core 14 are described in the parent U.S. patent application publication no. 2004/0082407 A1, which was previously incorporated by reference in its entirety.

Generally, cover 16 is tough, cut-resistant, and selected from conventional materials used as golf ball covers based on the desired performance characteristics. The cover may be comprised of one or more layers. Cover materials such as ionomer resins, blends of ionomer resins, thermoplastic or thermoset urethane, and balata, can be used as known in the art. However, it is understood by one skilled in the art that cover layer 16, alternatively, or in addition to outer core 14 and/or inner core 12 includes a polymer composition comprising a peroxide-cured diene rubber formulation that is substantially free of ZDA and, optionally, other additives described above.

Cover 16 is, preferably, a resilient, non-reduced specific gravity layer. Suitable materials include any material that allows for tailoring of ball compression, coefficient of restitution, spin rate, etc. and are disclosed in the parent U.S. patent application Ser. No. 10/279,506, which was previously incorporated by reference in its entirety.

In one example illustrated in FIG. 1, cover 16 comprises an inner cover 17 and an outer cover 18. As disclosed in the U.S. Pat. Nos. 5,885,172 and 6,132,324, which are incorporated herein by reference in their entireties, outer cover layer 18 is formed from a soft thermoset material, such as cast polyurethane, and inner cover 17 is formed from a rigid material to provide ball 10 with progressive performance. Thus, the ball has the low spin and long distance benefits of a hard cover ball when struck with a driver club and high spin and soft feel characteristics of a traditional soft cover ball when struck with short irons.

Inner cover layer 17 is formed preferably from a hard, high flexural modulus, resilient material which contributes to the low spin, distance characteristics of the presently claimed balls when they are struck for long shots (e.g. driver or long irons). Specifically, the inner cover layer materials have a Shore D hardness of from about 60 to about 80, preferably about from about 62 to about 74 and, most preferably, from about 66 to about 70. The flexural modulus of inner cover layer 17 is at least about 60,000 psi, preferably from about 65,000 psi to about 120,000 psi and, most preferably, at least about 70,000 psi. The thickness of the inner cover layer can range from about 0.02 inch to about 0.1 inch, preferably from about 0.03 inches to about 0.08 inch and, most preferably, about 0.035 inch to about 0.040 inch.

Outer cover layer 18 is formed, preferably, from a relatively soft thermoset material as described in U.S. Pat. No. 5,692,974, which was previously incorporated by reference in its entirety. Thermoset polyurethanes and polyureas are preferred for outer cover layers 18 of ball 10 of the present invention. However, it is understood by one skilled in the art that one of inner cover layer 17 or outer cover layer 18 may, alternatively, include the polymeric composition described above, specifically, a polymer include at least a peroxide-cured diene rubber formulation that is substantially free of ZDA and, optionally, the additional additives described above.

In an alternative embodiment, as illustrated in FIG. 2, golf ball 20 includes an inner core 22, an intermediate layer 24 and a thin soft cover 26. In this example, intermediate layer 24 comprises the polymeric components described above, which is a peroxide-cured diene rubber formulation that is substantially free of ZDA.

Optionally, in addition to intermediate layer 24, or instead of intermediate layer 24, inner core 22 is formed from the polymeric composition described above, namely a rubber composition comprising a peroxide-cured diene rubber formulation that is substantially free of ZDA and, optionally, other additional additives described above.

Golf balls 10 and 20 have at least one member/layer that comprises a polymer having at least a peroxide-cured diene rubber formulation that is substantially free of ZDA. Additionally, golf balls 10 and 20 have a compression greater than about 60, more preferably greater than about 70 and, even more preferably, greater than about 80. These balls exhibit CoR of at least about 0.79 at 125 feet per second and, more preferably, at least about 0.81 at 125 feet per second. These balls also exhibit CoR of at least about 0.7 at 160 feet per second and more preferably at least 0.75 at 160 feel per second.

Initial velocity of a golf ball after impact with a golf club is governed by the United States Golf Association (“USGA”). The USGA requires a regulation golf ball to have an initial velocity of no more than 250 feet per second ±2% or 255 feet per second. The USGA initial velocity limit is related to the ultimate distance that a ball may travel (280 yards±6%), and is also related to the CoR. The CoR is the ratio of the relative velocity between two objects after direct impact to the relative velocity before impact. As a result, the CoR can vary from 0 to 1, with 1 being equivalent to a perfectly or completely elastic collision and 0 being equivalent to a perfectly or completely inelastic collision. Since the CoR of a ball directly influences the initial velocity and travel distance of the ball after club collision, golf ball manufacturers are interested in this characteristic for designing and testing golf balls.

One conventional technique for measuring CoR uses a golf ball or golf ball subassembly, air cannon, and a stationary steel plate. The steel plate provides an impact surface weighing about 100 pounds or about 45 kilograms. A pair of ballistic light screens are spaced apart and located between the air cannon and the steel plate. The ball is fired from the air cannon toward the steel plate over a range of test velocities from 50 ft/s to 180 ft/s. As the ball travels toward the steel plate, it activates each light screen so that the time at each light screen is measured. This provides an incoming time period proportional to the incoming velocity of the ball. The ball impacts the steel plate and rebounds though the light screens, which again measure the time period required to transit between the light screens. This provides an outgoing transit time period proportional to the outgoing velocity of the ball. The CoR is calculated by the ratio of the outgoing transit time period to the incoming transit time period, CoR=Tₒᵤₜ/Tᵢₙ.

Another CoR measuring method uses a titanium disk. The titanium disk intending to simulate a golf club is circular, and has a diameter of about 4 inches, and has a mass of about 200 grams. The impact face of the titanium disk may also be flexible and has its own coefficient of restitution, as discussed further below. The disk is mounted on an X-Y-Z table so that its position can be adjusted relative to the launching device prior to testing. A pair of ballistic light screens are spaced apart and located between the launching device and the titanium disk. The ball is fired from the launching device toward the titanium disk at a predetermined test velocity. As the ball travels toward the titanium disk, it activates each light screen so that the time period of the ball transiting between the light screens is measured. This provides an incoming transit time period proportional to the incoming velocity of the ball. The ball impacts the titanium disk, and rebounds through the light screens which measure the time period to transit between the light screens. This provides an outgoing transit time period proportional to the outgoing velocity of the ball. CoR can be calculated from the ratio of the outgoing time period to the incoming time period along with the mass of the disk and ball:
CoR=((Tₒᵤₜ/Tᵢₙ)*(Mₑ+M_{b})+M_{b})/Mₑ

Golf balls with soft cores have been utilized to provide balls with good feel for better control. Recently, a soft core has been developed that is also capable of high initial velocity when impacted by a high velocity driver club. Such technology is discussed in commonly owned co-pending U.S. patent application Ser. No. 09/992,448 entitled “Low Spin Soft Compression Performance Golf Ball”, filed on Nov. 16, 2001. The disclosure of this co-pending application is incorporated herein by reference in its entirety.

A “Mooney” viscosity is a unit used to measure the plasticity of raw or unvulcanized rubber. The plasticity in a Mooney unit is equal to the torque, measured on an arbitrary scale, on a disk in a vessel that contains rubber at a temperature of 100° C. and rotates at two revolutions per minute. The measurement of Mooney viscosity is defined according to ASTM D-1646.

Compression is measured by applying a spring-loaded force to the golf ball center, golf ball core or the golf ball to be examined, with a manual instrument (an “Atti gauge”) manufactured by the Atti Engineering Company of Union City, N.J. This machine, equipped with a Federal Dial Gauge, Model D81-C, employs a calibrated spring under a known load. The sphere to be tested is forced a distance of 0.2 inch (5 mm) against this spring. If the spring, in turn, compresses 0.2 inch, the compression is rated at 100; if the spring compresses 0.1 inch, the compression value is rated as 0. Thus more compressible, softer materials will have lower Atti gauge values than harder, less compressible materials. The approximate relationship that exists between Atti or PGA compression and Riehle compression has previously been expressed as:
(Atti or PGA compression)=(160-Riehle Compression)

Thus, a Riehle compression of 100 would be the same as an Atti compression of 60. As used herein, the term “material hardness” refers to indentation hardness of non-metallic materials in the form of a flat slab or button as measured with a durometer. The non-metallic materials include thermoplastic elastomers, vulcanized (thermoset) rubber, elastomeric materials, cellular materials, gel-like materials, and other rubbers or plastics. The durometer has a spring-loaded indentor that applies an indentation load to the slab, thus sensing its hardness. The material hardness can indirectly reflect upon other material properties, such as tensile modulus, resilience, plasticity, compression resistance, and elasticity. Standard method to measure the material hardness include ASTM D2240-02a titled Standard Test Method for Rubber Property-Durometer Hardness. Material hardness reported herein is in Shore D or C units.

As used herein, the term “on-ball hardness” refers to the hardness of a portion of a golf ball measured directly on the golf ball (or other spherical surface), and is completely different from the material hardness in nature and in value. The difference in value stems primarily from the components of the golf ball that underlie the portion being measured (i.e., center, core and/or layers), including their construction, size, thickness, and material composition. Therefore, it is understood to one of ordinary skill in the art that the on-ball hardness and the material hardness are not correlated or convertible.

Other than in the operating examples, or unless otherwise expressly specified, all of the numerical ranges, amounts, values and percentages such as those for amounts of materials, and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

While it is apparent that the illustrative embodiments of the invention disclosed herein fulfill the objectives stated above, it is appreciated that numerous modifications and other embodiments may be devised by those skilled in the art. One such modification is that the outer surface can be flush with the inner surface free ends or it can extend beyond the free ends. Therefore, it will be understood that the appended claims are intended to cover all such modifications and embodiments, which would come within the spirit and scope of the present invention.

1. A golf ball comprising a core, a cover layer, and optionally at least one intermediate layer disposed between the core and the cover, wherein at least one of the core, the at least one intermediate layer, and the cover layer comprise a polymer composition comprising a diene rubber cured with a free radical initiator and said composition is substantially free of zinc diacrylate or zinc methacrylate.

2. The golf ball of claim 1, wherein the cured diene rubber comprises a diene rubber cured with peroxide.

3. The golf ball of claim 2, wherein the diene rubber comprises polybutadiene, polyisoprene, ethylene propylene diene monomer rubber, ethylene propylene rubber, natural rubber, balata, butyl rubber, halobutyl rubber, hydrogenated nitrile butadiene rubber, nitrile rubber, silicone rubber, styrene butadiene rubber, styrenic block copolymer, or a combination thereof.

4. The golf ball of claim 1, wherein the initiating agent comprises dicumyl peroxide; 2,5-dimethyl-2,5-di(t-butylperoxy) hexane; 2,5-dimethyl-2,5-di(t-butylperoxy)hexyne; 2,5-dimethyl-2,5-di(benzoylperoxy)hexane; 2,2′-bis(t-butylperoxy)-di-iso-propylbenzene; 1,1-bis(t-butylperoxy)-3,3,-5-trimethyl cyclohexane; n-butyl 4,4-bis(t-butyl-peroxy)valerate; t-butyl perbenzoate; benzoyl peroxide; n-butyl 4,4′-bis(butylperoxy) valerate; di-t-butyl peroxide; 2,5-di-(t-butylperoxy)-2,5 dimethyl hexane; lauryl peroxide; t-butyl hydroperoxide; a-a bis(t-butylperoxy) diisopropylbenzene; di(2-t-butyl-peroxyisopropyl)benzene peroxide; 3,3,5-trimethyl cyclohexane; di-t-amyl peroxide; di-t-butyl peroxide; or a combination thereof.

5. The golf ball of claim 1, wherein said polymer composition further comprises a cis-to-trans catalyst.

6. The golf ball of claim 5, wherein the cis-to-trans catalyst comprises an organosulfur compound, metal-containing organosulfur compound, a substituted or unsubstituted aromatic organic compound that does not contain sulfur or metal, an inorganic sulfide compound, an aromatic organometallic compound, an element from Group VI A, or a combination thereof.

7. The golf ball of claim 6, wherein the organosulfur compound comprises PCTP or a metal salt thereof.

8. The golf ball of claim 5, wherein the polymer composition comprises from about 0.005 to about 3.0 parts per hundred of the cis-to-trans catalyst.

9. The golf ball of claim 1, wherein the cured diene rubber comprises a diene rubber cured with sulfur.

10. The golf ball of claim 9, wherein the sulfer comprises sulfur; insoluble sulfur; 4-morpholinyl-2-benzothiazole disulfide; dipentamethylenethiuram hexasulfide; thiuram disulfides; N-oxydiethylene 2-benzothiazole sulfonamide; N,N-diorthotolyguanidine; bismuth dimethyldithiocarbamate; N-cyclohexyl 2-benzothiazole sulfonamide; N,N-diphenylguanidine, or a combination thereof.

11. The golf ball of claim 1, wherein the polymer composition comprises a silicone material.

12. The golf ball of claim 1, wherein the core comprises the cured diene rubber that is substantially free of ZDA.

13. The golf ball of claim 12, wherein the at least one intermediate layer comprises a partially or fully neutralized ionomer.

14. The golf ball of claim 12, wherein the cover layer comprises partially- or fully-neutralized ionomers, metallocene-catalyzed polymers, single-site catalyzed polymers, polyesters, polyethers, balata, cross-linked diene rubbers, styrene block copolymers, polyurethanes, polyureas, polyurethane ureas, polyurea-urethanes, or non-ionic fluoropolymers, or a combination thereof.

15. The golf ball of claim 12, wherein the core has a diameter of about 1.4 inches or less, the at least one intermediate layer has a thickness of from about 0.1 to about 0.5 inch and the cover layer has a thickness of from about 0.005 to about 0.3 inch.

16. The golf ball of claim 1, wherein the cover layer comprises an inner cover layer encasing the core and an outer cover layer encasing the inner cover layer, wherein the outer cover layer comprises the cured diene rubber that is substantially free of ZDA.

17. The golf ball of claim 16, wherein the inner cover layer comprises polyamides, polyesters, fluoropolymers, silicones, ionomers, cross-linked rubbers, or a combination thereof.

18. The golf ball of claim 16, wherein the core comprises an inner core and an outer core.

19. The golf ball of claim 18, wherein each of the inner cover layer and the outer cover layer has a thickness of from about 0.005 inch to about 0.05 inch.

20. The golf ball of claim 1, wherein the core comprises an inner core and an outer core, wherein the inner core is pre-formed non-spherical, wherein the outer core comprises the cured diene rubber that is substantially free of ZDA.

21. The golf ball of claim 1, wherein the core comprises the cured diene rubber that is substantially free of ZDA and the intermediate layer comprises diene polymer cross-linked with at least about 50 phr of a reactive co-agent.

22. The golf ball of claim 21, wherein the core has a diameter of about 1.62 inches, the intermediate layer has a thickness of about 0.0078 to about 0.05 inch and the cover layer has a thickness of from about 0.01 to about 0.05 inch.

23. The golf ball of claim 1, wherein the intermediate layer comprises the cured diene rubber that is substantially free of ZDA.

24. The golf ball of claim 23, wherein the cover layer is formed from a thermoset material and the core has a hardness of at least about 70 Shore C.

25. The golf ball of claim 1, wherein the core comprises an inner core and an outer core, wherein the outer core comprises the cured diene rubber that is substantially free of ZDA.

26. The golf ball of claim 25, wherein the inner core comprises a low deformation material.

27. The golf ball of claim 25, wherein the cover layer comprises ionomer resins, blends of ionomer resins, thermoplastic or thermoset urethane, and balata.

28. The golf ball of claim 1, wherein at least one of the core, the cover layer, and the intermediate layer has a compression of about 50 or more.
